(19) United States
(12) Patent Application Publication
(10) Pub. No.: US 2024/0383038 A1
(43) Pub. Date: Nov. 21, 2024

(54) SELECTIVE DEPOSITION AND FUSION ADDITIVE MANUFACTURING METHOD WITH REDUCED BINDER CONTENT

(71) Applicant: THE TEXAS A&M UNIVERSITY SYSTEM, COLLEGE STATION, TX (US)

(72) Inventors: MIGUEL HOFFMANN, COLLEGE STATION, TX (US); ALAA ELWANY, COLLEGE STATION, TX (US)

(21) Appl. No.: 18/667,241

(22) Filed: May 17, 2024

Related U.S. Application Data
(60) Provisional application No. 63/502,749, filed on May 17, 2023.

(51) Int. Cl. B22F 10/18; B22F 10/64; B33Y 10/00; B33Y 40/20; B33Y 70/10

(52) U.S. Cl. CPC B22F 10/18; B33Y 10/00; B33Y 70/10; B22F 10/64; B33Y 40/20

(57) ABSTRACT

A SDFAM method includes forming a patterned layer of metallic paste on a build structure. The metallic paste has a solvent and a binder. The method also includes removing the solvent and the binder from the metallic paste to generate a patterned layer of metallic powder. The SDFAM method also includes applying thermal energy to the patterned layer of metallic powder to fuse the patterned layer of metallic powder into a patterned layer of solid metallic build material, and repeating the forming, the removing, and the applying to form a plurality of patterned layers of solid metallic build material to create an object.

### RELATED APPLICATION

This application is based upon prior filed copending Application No. 63/502,749 filed May 17, 2023, the entire subject matter of which is incorporated herein by reference in its entirety.

### TECHNICAL FIELD

The present disclosure relates to the field of manufacturing, and, more particularly, to additive manufacturing and related methods.

### BACKGROUND

Additive manufacturing (AM), colloquially known as 3D printing, is a collective term describing an emerging set of technologies that enable the production of complex functional components by successively joining materials layer-by-layer from digital model data [1]. AM technologies have witnessed notable advancements over the past two decades, resulting in increasing their level of maturity and transitioning many of them from prototyping tools to viable manufacturing methods used to produce end-use parts in the aerospace, automotive, and biomedical industries [2, 3, 4, 5]. Fabrication of metallic components using AM is predominantly done via powder bed fusion (PBF) and directed energy deposition (DED) processes [3] due to their ability to produce fully dense parts with mechanical properties matching, and at times exceeding, those of conventional manufacturing routes such as casting and forging. This is achieved by employing a focused thermal energy source (e.g., laser or electron beam) to selectively fuse raw metallic feedstock, in the form of powder or wire, via full melting [6, 7].

### SUMMARY

Generally, a selective deposition and fusion (SDF) additive manufacturing (AM) method comprises forming a patterned layer of metallic paste on a build structure, the metallic paste comprising a solvent and a binder, and removing the solvent and the binder from the metallic paste to generate a patterned layer of metallic powder. The SDFAM method also includes applying thermal energy to the patterned layer of metallic powder to fuse the patterned layer of metallic powder into a patterned layer of solid metallic build material, and repeating the forming, the removing, and the applying to form a plurality of patterned layers of solid metallic build material to create an object (i.e., with no infill).

In particular, the SDFAM method may also include generating the metallic paste by combining a metallic powder, the binder, and the solvent in a mixer device. The forming of the patterned layer of metallic paste may comprise forming the metallic paste only in areas for creating the object. In some embodiments, the applying of the thermal energy may comprise using a scanning laser to generate the thermal energy.

Also, the SDFAM method may include a post-processing for the object. The post-processing may comprise applying thermal energy to the object, and the post-processing may be less than 24 hours. The forming of the patterned layer of metallic paste may comprise extruding the patterned layer of metallic paste.

For example, the metallic paste may comprise at least 90 wt % metal powder. The metallic paste may comprise less than 1 wt & binder. The binder may comprise carboxymethyl cellulose, and the solvent may comprise deionized water, for example. The removing of the solvent and the binder may comprise heating the metallic paste to a first temperature. The removing of the solvent and the binder may comprise a single stage process.

### BRIEF DESCRIPTION OF THE DRAWINGS

FIG. 1A is a perspective view of a SDFAM printer device, according to the present disclosure.

FIG. 1B is a schematic cross-sectional view of an extrusion device from the SDFAM printer device of FIG. 1A.

FIG. 1C is a schematic side view of the extrude metallic paste from the SDFAM printer device of FIG. 1A.

FIG. 2 is an image from an optical and scanning electron micrograph of a run according to the present disclosure.

FIGS. 3-6 are images of a method of additive manufacturing, according to the present disclosure.

FIG. 7 is a flowchart of a method of additive manufacturing, according to the present disclosure.

FIGS. 8A-8B is a schematic diagram of an additive manufacturing system, according to the present disclosure.

FIGS. 9 is a diagram of micrographs of samples from test parts fabricated using the SDFAM method, according to the present disclosure.

FIGS. 10-13 are diagrams of depth profiles measured for the virgin SS316L powder using secondary-ion mass spectrometry, according to the present disclosure.

### DETAILED DESCRIPTION

Despite the unique capabilities offered by PBF and DED processes, they also come with their own challenges. Some of these challenges include high capital costs [8], safety hazards due to the use of high energy sources and handling of loose metallic powders [9], extreme complexity of the processes that make fabricated parts susceptible to defects [10, 11], variability [12, 13], and anisotropic microstructures that influence mechanical properties [14].

Indirect metal AM processes such as material extrusion (MEX) [15, 16, 17, 18] may address some of these challenges. MEX are AM processes “in which material is selectively dispensed through a nozzle or orifice” [1], in contrast to melt based PBF and DED processes. MEX processes may produce metallic parts in a manner analogous to powder injection molding by processing a mixture of metallic powders and binders to produce “green” parts that must be subsequently thermally treated to achieve functional properties. They are generally categorized into fused deposition technologies that employ solid feedstocks (i.e., filaments, granules) [19, 20] and DIW technologies that process pastes and colloidal suspensions [21, 22]. Metal fused deposition technologies use three main types of extrusion systems: (i) filament-based MEX, i.e., fused filament fabrication (FFF), that process a continuous filament input, locally liquefied in a heating reservoir [23, 24]; (ii) plunger-based MEX that inject rods or granules through a nozzle [19, 20]; and (iii) screw-based MEX that process granulated (i.e., granules, 3pellets) feedstock [25, 26]. Commercialized examples of these three extrusion system variants are offered by Mark forged [27], Desktop Metal [28], and AIM3D GmbH [26], respectively.

Regardless of the type of extrusion system, the solid feedstock typically incorporates 45-65 Volume percentage metal powder content embedded in a multicomponent binder system [19]. The high binder content introduces the need for a two-step debinding protocol, including solvent or catalytic debinding where 50-90 vol % of the binder is removed and thermal debinding (i.e., pyrolysis). In addition to the need for dedicated equipment, debinding procedures in these cases may last several days, proportionally to the dimensions and cross-section thickness of the printed component [19]. The geometric accuracy and attainable mechanical properties are typically on par with those reported for parts produced using metal injection molding, often exceeding the 95% density standards [29, 30].

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

In prior art additive manufacturing powder bed processes, there may be difficulties. For example, these issues may comprise: dealing with loose powders; including health and safety hazards; the time-intensive machine set-up when exchanging materials; and the risk of material cross-contamination.

Further, there are feedstock inefficiencies and high cost to print a part with dimensions (w, l, h) on a printer with build volume (W, L, H). The minimum volume of powder required is (W, L, h) where W, L is the area of the build plate. Thus, it is often prohibitively expensive to build large-sized components due to the large quantity of powder that would be required. Additionally, the powder must have specific properties to ensure adequate flowability during powder spreading, further contributing to high feedstock costs.

There are also geometrical limitations. Parts produced with partial infills or lattice structures cannot be fully enclosed due to powder entrapment. Surface roughness detriment as a consequence of partially melted or sintered powder that surrounds the part's perimeter.

There are two key limitations associated with producing metallic parts using metal fused deposition technologies: (1) extremely long post-processing (i.e., debinding and sintering) times, often several days [28, 31], and (2) limited ability to achieve fully dense parts (with no infill) with thicknesses over 4 mm [32]. Both limitations stem from the high binder content, typically around 45 vol % [19], in the filament or pellet feedstocks. The present disclosure provides an approach to these limitations by employing DIW to produce metallic parts.

DIW technologies, also called robocasting, offer a simplified post-processing route by replacing most of the binder content with a volatile solvent that evaporates during the printing step. DIW has been explored for the fabrication of ceramic components [33, 34, 35, 36], biomaterial scaffolds [37, 38], and polymers [39, 40]. However, metal DIW studies [41, 42, 43, 44, 45] are sparse and of limited success, with parts exhibiting poor quality, including limited geometric fidelity and apparent defects such as extensive macroporosity, uneven layers, and slumping. Sintered densities above 90% were only achieved by infiltrating melted copper into sintered parts [46], or at the expense of long post-processing times (e.g., 12-48 hours part drying before debinding and sintering) and warping [47, 48].

The present disclosure provides a new class of DIW, which is described as SDFAM. This new SDFAM method can fabricate high-quality (i.e., over 95% dense, no macroporosity, warping, or apparent defects) metallic parts, requiring just 22 hours of thermal post-processing.

This is a contrast to existing prior art approaches. This is achieved through a framework that includes: (1) synthesis of metal alloy pastes with minimal binder content, (2) design and implementation of a synchronized two-step extrusion mechanism, (3) an experimentally-driven approach to evaluate the influence of crucial printing parameters on part density (PD) and surface roughness (SR), (4) multi-objective optimization of printing parameters to maximize PD and minimize SR, and (5) evaluation of thermal post-processing strategies, including hydrogen and vacuum sintering.

### 2. Methodology

A metal paste with the composition shown in Table 1 was custom synthesized using a vacuum mixer (VPMmini, Whip Mix Corporation, USA) to minimize air porosity. In this exemplary application, the paste consists of 89.2 wt % spherical SS316L powder (EOS of North America Inc., USA) with the chemical composition shown in Table 2 and a particle size distribution of D10=22 μm, D50=37 μm and D90=58 μm; 0.5 wt % carboxymethyl cellulose (CMC, MSE Supplies LLC, USA) serving as the binder; and deionized water (diH2O). It should be appreciated that other metal powders/pastes/compounds can be used with the herein disclosed SDFAM method. As reported by the supplier, the SS316L powder's tapped and true densities are 4.6 g/cm³ and 7.953 g/cm³, respectively.

TABLE 1
Feedstock composition

| Component | SS316L | CMC | diH₂O |
|---|---|---|---|
| Density (ρ, g/cm³) | 7.953 | 0.710 | 0.998 |
| Mass fraction (ϕ) | 0.892 | 0.005 | 0.103 |

TABLE 2
Chemical composition of the SS316L powder (provided by the supplier)

| Element | Fe | Cr | Ni | Cu | Mn | Si | Mo | C | S | P | N |
|---|---|---|---|---|---|---|---|---|---|---|---|
| Composition | Bal. | 17.31 | 13.74 | 0.03 | 1.42 | 0.42 | 2.63 | 0.017 | 0.008 | 0.014 | 0.10 |
| (wt %) | | | | | | | | | | | |

The theoretical density of the paste (ρ_{paste,th}) can be calculated via the inverse rule of mixtures[49]:

$${ρ}_{paste , th} = {( \frac{{ϕ}_{m}}{{ρ}_{m}} + \frac{{ϕ}_{b}}{{ρ}_{b}} + \frac{{ϕ}_{s}}{{ρ}_{s}} )}^{- 1} \qquad ( 1 )$$

where ϕ is the component's mass fraction, ρ is the component's density, and the subscripts m, b, and s denote metal, binder, and solvent, respectively.

### 2.2. SDFAM Printer Design and Implementation

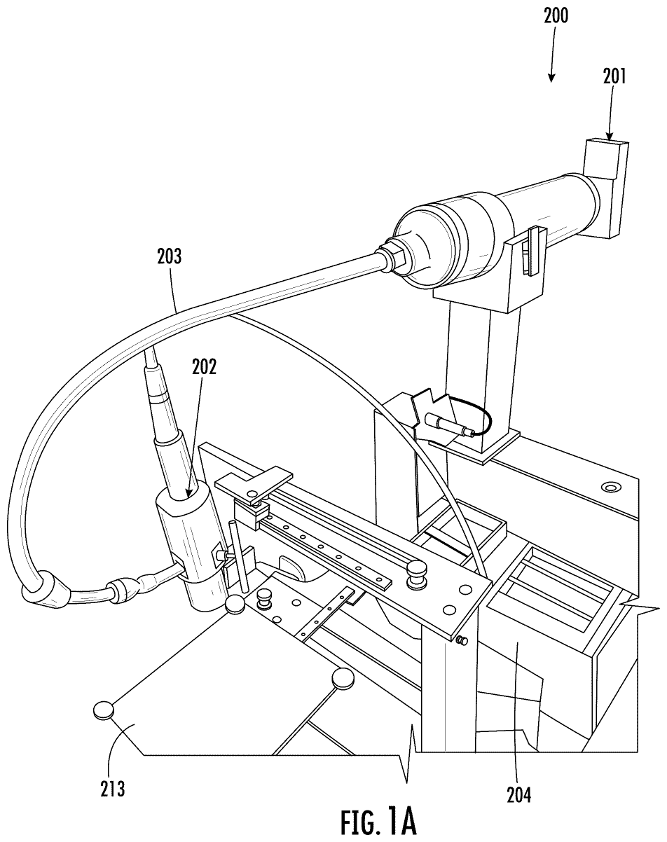

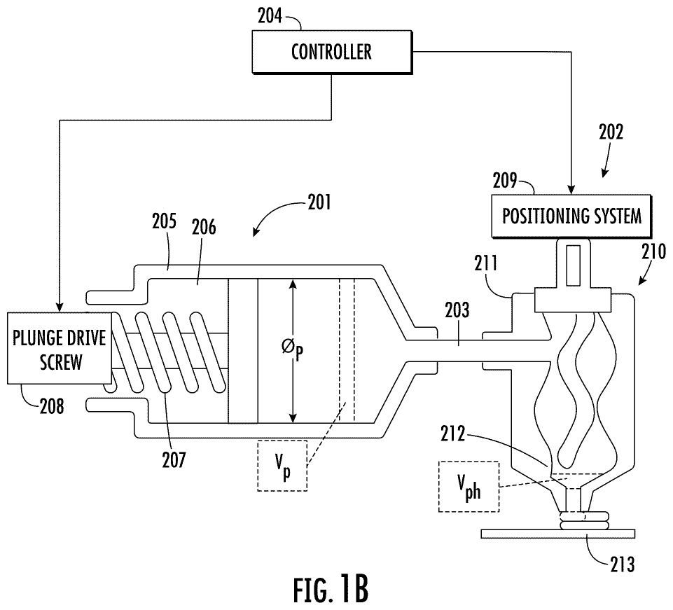

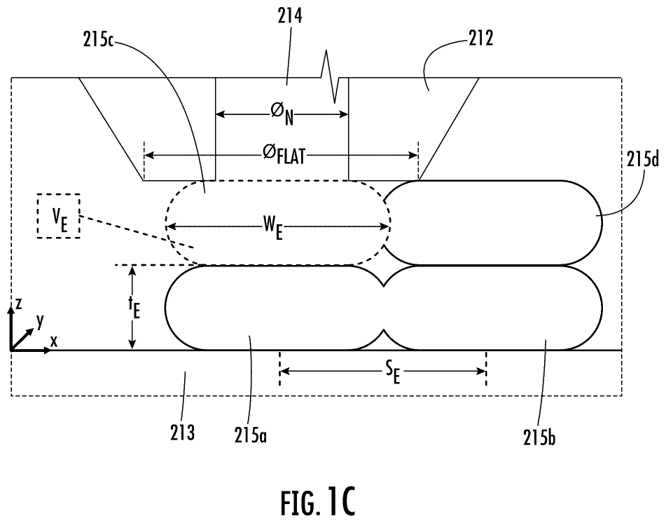

A synchronized two-stage extrusion mechanism was developed to assess the printability of the synthesized feedstock using SDFAM. The extrusion mechanism (FIGS. 1A-1C) includes a piston extruder driven by a stepper motor (closed loop NEMA 23) coupled with a worm-gear reducer (80:1) synchronized with a progressive cavity pump (vipro-HEAD 3, ViscoTec America Inc., Kennesaw, GA) serving as the printhead. The piston extruder stores the paste in a polycarbonate tube (capacity: 1,000 cm³) and delivers the feedstock to the printhead via polyurethane tubing. The printhead consists of a helical rotor that rotates eccentrically within a helical stator, forming constant cavities for volumetric material flow [50]. The rotation is achieved by a 24 V stepper motor with a 12:1 gearbox, permitting precise deposition rate and start/stop control.

The printhead was mounted on the x-axis gantry of a modified desktop FFF printer (Invent3D, Vista AST LLC, Youngstown, OH). Cartesian motion is directed by stepper motors (NEMA 17). The X and Y (planar) axes are belt-driven, and the Z (vertical) axis is lead screw-driven. The synchronization of the toolpath movement and material dispensing is controlled using an open-source Duet2 WiFi controller board [51] that operates with the RepRapFirmware firmware [52], permitting the customization and testing of all hardware-relevant parameters (e.g., printhead motor microsteps). In addition, the firmware was customized to enable the SDFAM printer to process G-code [53] generated with an open-source FFF slicer (PrusaSlicer 2.3.3[54 ]). Additional printer components include a BLTouch auto-leveling sensor and a heated substrate with a polyethyleneimine surface. Although multiple MEX parameters can be manipulated using the FFF slicer, only six are included in most G-code commands. Equation 2 shows the typical G-code structure executed by FFF firmware:

$$Gg Xx Yy Fv {El}_{E} \qquad ( 2 )$$

where g specifies the type of printhead movement (e.g., g=1 for linear motion), x and y are the printhead's target coordinates, v is the printing speed and l_{E} is the extrusion length. A negative l_{E} value in Equation 2 implies a filament retraction that aims to pause the material flow during non-extrusion printhead moves.

The extrusion parameters are derived from the principle of mass conservation, which can be expressed in terms of the feedstock volume entering the printhead ( [symbol] ) and the extrudate's volume ( [symbol] ). In FFF, the feedstock entering the printhead is a filament (i.e., thin cylinder) of diameter Φ_{f}; thus, [symbol] _{slicer} is simply

$$= 0.25 π {ϕ}_{f}^{2} {l}_{E} \qquad ( 3 )$$

As shown in FIGS. 1A-1C, PrusaSlicer assumes that the extrudate has an oblong cross-section (AE), deposited as the printhead travels a distance (l_{T}) based on the x, y coordinates from Equation 2. Therefore, the extrudate volume ( [symbol] ) is expressed as

$$= {l}_{T} {m}_{E} {A}_{E} = {l}_{T} {m}_{E} ( {t}_{E} ( {w}_{E} - {t}_{E} ) + 0.25 π {t}_{E}^{2} ) \qquad ( 4 )$$

where m_{E} is the extrusion multiplier, t_{E} is the extrudate thickness (i.e., the layer height), and w_{E} is the extrusion width, usually equal to or slightly larger than the nozzle's diameter (N). Equating Equation 3 to Equation 4 and solving for l_{E} yields:

$${l}_{E} = ( 4 ( {w}_{E} - {t}_{E} ) + π {t}_{E} ) {l}_{T} {m}_{E} {t}_{E} / ( π {ϕ}_{f}^{2} ) \qquad ( 5 )$$

Typically, the space between adjacent extrudate tracks (S_{E}, also known as hatch spacing) is less than w_{E} since an overlap factor reduces the cross-sectional area of voids (A_{void}); thus, for tangential extrudates, A_{void} is computed using Equation 6, and S_{E} is calculated by dividing the idealized extrudate cross-section by t_{E}, as shown by Equation 7.

$${A}_{void} = {t}_{E}^{2} ( 1 - 0.25 π ) \\ {S}_{E} = {A}_{E} {t}_{E}^{- 1} = {w}_{E} - {t}_{E} ( 1 - 0.25 π ) \qquad ( 6 - 7 )$$

To clarify, w_{E} controls the extrudate's span by adjusting the material flow and modifying the printhead's toolpath proportionally using Equation 7. In contrast, m_{E} modifies the material flow rate, thereby altering the extrudate dimensions; however, S_{E} and thus the toolpath is unchanged.

In addition to controlling the material flow, the selected parameters alter the pressure applied onto the extrudate during deposition. Increasing m_{E} will initially increase the effective extrudate width; but, if this width increases beyond the nozzle's flat diameter (flat in FIG. 1C), a portion of the extrudate may curl upwards, compromising the homogeneity of the layer. Increasing w_{E} or m_{E} will increase the interlayer contact area, possibly at the detriment of the part's geometrical and surface accuracy. In contrast, increasing t_{E} or decreasing w_{E} produces a more circular extrudate cross-section, resulting in a lower interlayer contact area and higher voids.

To explore the combined effects of w_{E}, t_{E} and m_{E} on density, two adjacent extrudates are discussed and their geometric density (ρ_{geometric}) is defined as the filled percentage of an ideal void-less area (A_{R}), i.e., a rectangular area with base S_{E}, by the hypothetical oblong area (A_{H}). Expressions for A_{R} and A_{H} are given by Equations 8 and 9, respectively, which assume that m_{E} only affects extrudate cross-sections by proportionally increasing their width.

$${A}_{R} = {t}_{E} {w}_{E} - {t}_{E}^{2} ( 1 - 0.25 π ) \\ {A}_{H} = {m}_{E} {t}_{E} {w}_{E} - {t}_{E}^{2} ( 1 - 0.25 ( π - θ + sin θ ) ) \qquad ( 8 - 9 )$$

The angle θ given by Equation 10 defines the overlapping area of the extrudate tracks. Therefore, if |φ|>1 (i.e., no overlap) then A_{H} reduces to A_{H,r} (Equation 12).

$$θ = 2 {cos}^{- 1} ( φ ) \\ φ = ( {w}_{E} ( 1 - {m}_{E} ) + 0.25 π {t}_{E} ) {t}_{E}^{- 1} \\ {A}_{H , r} = 2 {t}_{E} ( {m}_{E} {w}_{E} - {t}_{E} ) + 0.5 π {t}_{E}^{2} \qquad ( 10 - 12 )$$

Thus, ρ_{geometric} for selected w_{E}, t_{E} and m_{E} values are computed using conditional Equation 13, which can be multiplied by the feedstock's theoretical density (ρ_{paste,th}, Equation 1) to obtain a density value in g/cm³.

$${ρ}_{geometric} = \{ \begin{matrix}{A}_{R}^{- 1} {A}_{H - r} , & if \vert φ \vert > 1 \\ {A}_{R}^{- 1} {A}_{H} , & otherwise\end{matrix} \qquad ( 13 )$$

As indicated in Equation 2, a single v value dictates the actions to be performed by at least three stepper motors: two (X, Y) to achieve the required Cartesian position and one (E) to control the material extrusion. Stepper motors move in discrete steps (i.e., fractions of a revolution); since MEX motors are commonly designed with a 1.8° step angle, their step pulses per revolution (Ms) equals 200. A 16 microstepping resolution is applied to all stepper motors used in this work to increase motion accuracy and resolution; thus, Ms=3200 steps/rev. A single v in Equation 2 is sufficient because the various motor rotational speeds (wᵢ) are predefined in the controller's firmware using:

$${w}_{i} = {vN}_{i} / ( {M}_{s} {M}_{g , i} ) \qquad ( 14 )$$

where the i subscript stands for the specific stepper motor (i.e., i=x, y, z for a Cartesian motor, i=pₕ for the printhead, and i=P for the piston extruder), M_{g,i} is the reduction gear ratio of motor i, and Ni stands for the steps motor i takes to move one distance unit. The N_{z} value for the leadscrew-driven Z-axis is obtained by dividing Mₛ by the leadscrew's pitch (L_{pitch,z}) as shown by Equation 15. Identical belt systems with pitch B_{pitch} and pulley tooth count of Cpt regulate the X and Y axes; therefore, Nₓ and N_{y} are computed using Equation 16.

$${N}_{z} = {{M}_{s} ( {L}_{pitch , z} )}^{- 1} {N}_{x} = {N}_{y} = {{M}_{s} ( {B}_{pitch} {C}_{pt} )}^{- 1} \qquad ( 15 - 16 )$$

The Nₚₕ and N_{P} values are derived using the conservation law in terms of the volumes illustrated in FIG. 1C (Equation 17) and assuming ideal conditions for the feedstock flow behavior; thus:

$$= = = \qquad ( 17 )$$

where [symbol] and [symbol] were defined using equations 3 and 4, and [symbol] and [symbol] refer to the volumetric elements (FIG. 1B) supplied by the piston extruder and the printhead, respectively.

The piston extruder outputs a specific volume per revolution based on the piston's lead screw pitch (L_{pitch,P}) and the piston's cross-sectional area with diameter P; thus, [symbol] is calculated using Equation 18. The printhead dispenses material based on the rotational speed of its stepper motor and the particular stator-rotor geometry. The geometry is proprietary, but the printhead's dispensed volume per revolution ( [symbol] ) is provided by the manufacturer; therefore, [symbol] is computed using Equation 19. The Nₚₕ and N_{P} values can then be computed by equating Equations 18 and 3 and solving for N_{P} (Equation 20), and equating Equations 19 and 3 and solving for Nₚₕ (Equation 21).

$$= ( 0.25 π {ϕ}_{P}^{2} {L}_{pitch , P} ) {N}_{P} {{l}_{E} ( {M}_{s} {M}_{g , P} )}^{- 1} \\ = {N}_{P} {l}_{E} {( {M}_{s} {M}_{g , P} )}^{- 1} \\ {N}_{p} = \frac{{M}_{s} {M}_{g , P}}{{L}_{pitch , P}} {( \frac{{ϕ}_{f}}{{ϕ}_{P}} )}^{2} \\ {N}_{ph} = ( 0.25 π {ϕ}_{f}^{2} ) \qquad ( 18 - 21 )$$

The Nₚₕ and N_{P} values obtained via Equations 20 and 21 permit the synchronization of the two-step extrusion with the printhead's translation. However, these values were derived by assuming ideal conditions, requiring calibration. The SDFAM calibration procedure includes two steps: (1) determining the experimental density of the paste (ρ_{paste,exp}) in the compressed state, which represents the paste's state when loaded into the piston extruder; and (2) adjusting NP and Nph to achieve a target volumetric flow rate (Q).

Four known volumes are filled with the paste and weighted. The mass versus volumes are then plotted, and the slope of their best-fit line equals ρ_{paste,exp}. The mass flow rate (\dot{m}) is estimated by extruding in midair for set time durations. The extrudates are collected into vials, sealed immediately after extrusion to prevent solvent evaporation, and weighted. The mass versus extrusion times are then plotted, and the slope of their best-fit line equals m. Finally, Q can be computed by dividing \dot{m} by the calculated ρ_{paste,exp}.

### 2.3. Experimental Design

The effects of four process parameters on surface roughness (SR) and printed density (PD) were investigated using the central composite design (CCD) surface response methodology. The four factors are extrudate thickness (t_{E}), extrusion width (w_{E}), extrusion multiplier (m_{E}), and printing speed (v). The factors were tested at five levels (Table 3). The CCD methodology has been employed in prior AM studies [26, 55] to analyze the effects of printing parameters on PD, SR, and other response variables (or quantities of interest).

To study the effects of the four process parameters, 31 cuboids (20×20×3 mm) were printed with the 3 mm thickness along the build direction (i.e., along the Z-axis in FIG. 1C) in the randomized order listed in table S1. All parts were printed using a 0.44 mm diameter tapered nozzle (Nordson EFD)

TABLE 3
Factors and levels for CCD study

| | levels | | | | |
|---|---|---|---|---|---|
| Factors | −2 | −1 | 0 | +1 | +2 |
| Extrudate thickness (t_{E}, mm) | 0.05 | 0.15 | 0.25 | 0.35 | 0.45 |
| Printing speed (v, mm/s) | 2 | 6.5 | 11 | 15.5 | 20 |
| Extrusion multiplier (m_{E}) | 0.9 | 1.0 | 1.1 | 1.2 | 1.3 |
| Extrusion width (w_{E}, mm) | 0.32 | 0.38 | 0.44 | 0.50 | 0.56 |

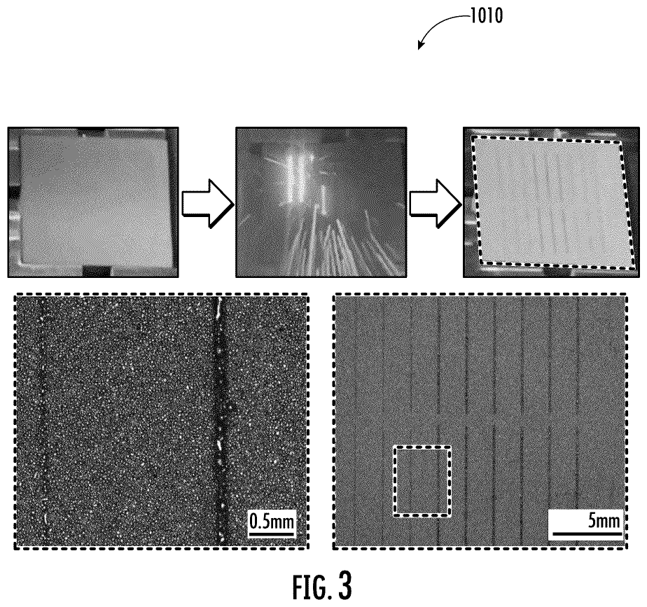

and with the substrate heated to 50° C. for the first layer and 75° C. for the rest of the print. The first layer of every cuboid was printed with t_{E}=0.32 mm, w_{E}=0.6 mm and v=5 mm/s to minimize potential first layer defects and ensure part adhesion to the substrate. Additionally, all cuboids were printed with a 100% infill density using an alternating diagonal rectilinear pattern and four perimeters per layer. FIG. 3 shows a representative cuboid printed with the four factors set to level 0.

The N influences the range of printable w_{E}, ranging from 0.73 N to 1.27 N. The value of 0.44 mm N was selected to facilitate benchmarking against existing metal FFF studies which typically use 0.4 to 0.8 mm nozzles. The maximum layer thickness (t_{E}=0.45 mm) is approximately the same as N, and the minimum (t_{E}=0.05 mm) stems from machine capabilities. The printhead's maximum volume flow (3.3 ml/min) limits the maximum v to 64 mm/s; however, due to the relatively large printhead weight (0.75 kg) compared to the weight of typical FFF extruders (≤0.50 kg) and preliminary printing tests, a maximum v of 20 mm/s was used for the CCD study.

To further analyze the effects of extrudate thickness (t_{E}) and extrusion width (w_{E}) on extrudate morphology, two sets of tensile specimens (30×20×5 mm) were printed using a 30% infill Hilbert curve pattern. This infill pattern creates a rectangular labyrinth within the model without extrudate overlaps. The first set included five tensile specimens varying t_{E} from 0.05 mm to 0.45 mm with a constant w_{E} of 0.50 mm. The five specimens in the second set employed a constant t_{E} of 0.32 mm while varying w_{E} from 0.32 mm to 0.56 mm. Both sets were printed using a 1.2 extrusion multiplier and a printing speed of 11 mm/s.

Statistical analyses were performed with RStudio software to obtain predictive models for PD and SR. Initial models included individual factors, pure quadratic, and two-way interactions, and the insignificant terms were then removed via backward elimination. The hierarchy principle was adhered to and kept main effects that were part of significant interactions or quadratic terms, even if the main effect p-value was higher than 0.05 (significance level), while also examining fitted model plots, interaction plots, and ANOVA statistics.

Multi-objective optimization was conducted with the Rstudio Non-dominated Sorting Genetic Algorithm (NSGA-II) [56] to maximize PD and minimize SR using the constraints listed in Equation 22. The population size, number of generations, crossover rate, and mutation probability were set to 200, 500, 0.8, and 0.05, respectively.

$$Minimize F = ( {PD}^{- 1} , SR ) \\ Subject to : \\ 0.05 \leq {t}_{E} \leq 0.45 \\ 2. \leq v \leq 20. \\ 0.9 \leq {m}_{E} \leq 1.3 \\ 0.32 \leq {w}_{E} \leq 0.56 \qquad ( 22 )$$

### 2.4. Thermal Treatments

Thermogravimetric analysis (TGA) of the paste was performed using a Q50 analyzer (TA Instruments, USA) to investigate the thermal behavior of the CMC binder and allow the determination of an initial heat treatment cycle. The TGA data were collected from 22 to 600° C. at a scanning rate of 10° C./min under a nitrogen atmosphere based on a 100 mg sample. Eight cuboids were printed using the optimal process parameters identified via multi-objective optimization and then randomly assigned into two groups for thermal debinding and sintering in a furnace.

The thermal treatment for four of the cuboids included (1) debinding with a heat rate of 5° C./min from room temperature to 580° C. for 2 hours dwell time followed by (2) by another 5° C./min ramp up to 1,380° C. (i.e., the sintering temperature) for 4 hours dwell time, and (3) cooling to room temperature. A 100% hydrogen atmosphere was used to minimize surface oxidation. The thermal treatment cycle required approximately 22 hours, including 10 hours of cooling. The thermal treatment for the other four cuboids was identical, except that a high vacuum (10-3 Pa) atmosphere without hydrogen was used during the sintering and cooling portions.

### 2.5. Characterization

Mass and dimensional measurements determined the parts' printed density (PD). The mass was measured with a milligram balance (Secura513-1S, Sartorius SQP, Germany) with a readability of 0.001 g. The volume was calculated from dimensions measured using a micrometer (MDC-25PXT, Mitutoyo America Corporation, Houston, TX) with a one μm accuracy.

The surface roughness (SR) of AM parts is typically reported using the arithmetical mean height of a line (Rₐ). However, some researchers have stated that Rₐ often fails to capture the complex topology of the surface accurately, promoting the mean height of a surface (Sₐ) as a better estimate of the surface quality [57, 58, 59]. In this work, SR values are reported using Sₐ obtained via a laser scanning wide-area 3D measurement system (VR-5000; KEYENCE Co., Osaka, Japan). The average SR values were obtained by measuring centered 15 mm2 areas from the cuboids' four vertical faces (i.e., the XZ and YZ printing directions) using an X40 magnification. Surfaces of as-printed parts were captured using the VR-5000 optical system and a JSM-7500F (JEOL, Peabody, MA) scanning electron microscope (SEM).

The density of the sintered parts was determined via Archimedes' suspension method [60] and micrographic cross-section analysis. Archimedes' method was performed using diH2O at 21° C. with the Secura513-1S balance and a universal specific gravity kit (SGK-C, Mineralab LLC, Mesa, AZ) and densities were reported as a percentage of the 8.0 g/cm³ theoretical density (TD) for SS316L [61, 62]. Sintered samples were sectioned along the XZ plane, mounted, ground using 120-4, 000 Grit sandpaper and polished for 5 min on a 0.05 μm cloth using colloidal silica to assess their porosity via optical microscopy (OM, Axio Vert A1, ZEISS, Oberkochen, Germany). Two cross-sections were prepared from hydrogen-sintered parts and two from vacuum-sintered parts. Two OM images per magnification (×5, ×10, ×20) were recorded for each cross-section from randomly selected positions. The images were processed with the ImageJ® software [63] to calculate the area percent porosity (i.e., the ratio between black pixels and total pixels). The measured values were averaged from the corresponding 12 images.

### 3. Experimental Results and Discussion

The theoretical density of the metal paste (ρ_{paste,th}), calculated by substituting the data in table 1 into Equation 1, was 4.50 g/cm³. The experimental density of the metal paste (ρ_{paste,exp}), derived from the best-fit line of weighted masses over known volumes, was 4.84 g/cm³, decreasing to 4.42 g/cm³ after solvent removal. The 7.44% difference between ρ_{paste,th} and ρ_{paste,exp} is attributed to possible paste dehydration during the transfer from the mixer to the piston tube, and the paste's compressibility since a degree of force was applied to ensure the paste filled the tested volumes. A similar degree of compaction is employed when loading the paste into the polycarbonate cartridge, so it's assumed that the experimental density provides a better approximation to the feedstock's actual density. The measured extrudate widths for the tensile specimens are tabulated in Table 4. The first set, where a constant w_{E} of 0.50 mm and extrusion multiplier (m_{E}) of 1.2 were selected and t_{E} was varied from 0.05 mm to 0.45 mm, exhibited a concave response. For the selected w_{E} and m_{E}, extrudate widths of 0.60 mm were expected. The extrudate width was not consistent across layers when t_{E}=0.05, where the top layer tracks are narrower than those in preceding layers, indicating that bottom layers were excessively compressed during the deposition of subsequent layers. The measured extrudate width reached a maximum of 0.76 mm for t_{E}=0.25, where the printed tracks appeared to be the most consistent across layers. Interestingly, increasing t_{E} further resulted in significantly thinner tracks. For the tensile sample with t_{E}=0.45, the measured extrudate width (0.46 mm) is narrower than the requested w_{E} (0.50 mm). In this case, t_{E} slightly exceeds the nozzle's diameter (0.44 mm), resulting in little extrudate compression and spreading during deposition.

The second set of tensile specimens, where a constant t_{E} of 0.25 mm and m_{E} of 1.2 were selected and w_{E} was varied from 0.32 mm to 0.56 mm, produced extrudates widths that on average, were 0.04 mm larger than expected (1.2 times w_{E}). For w_{E}=0.32, the measured extrudate width was essentially equal to the expected width. However, for w_{E}=0.38, w_{E}=0.44, and w_{E}=0.56, the measured extrudate width was larger than expected by 0.08 mm, 0.05 mm and 0.04 mm, respectively. Strangely, for w_{E}=0.50, the measured extrudate width was 0.04 mm smaller than expected.

TABLE 4
Effect of selected extrudate thickness (t_{E}) and
extrusion width (w_{E}) on measured extrudate width

| | |
|---|---|
| Variable t_{E} | Variable w_{E} |

| t_{E} (mm) | Width (mm) | w_{E} (mm) | Width (mm) |
|---|---|---|---|
| 0.05 | 0.53 ± 0.01 | 0.32 | 0.39 ± 0.02 |
| 0.15 | 0.73 ± 0.02 | 0.38 | 0.54 ± 0.02 |
| 0.25 | 0.76 ± 0.04 | 0.44 | 0.58 ± 0.01 |
| 0.35 | 0.57 ± 0.03 | 0.50 | 0.56 ± 0.01 |
| 0.45 | 0.46 ± 0.02 | 0.56 | 0.71 ± 0.01 |

The output responses of the central composite experimental design, printed density (PD) and surface roughness (SR), for the 31 parts are given in table S1. The PD ranged from 3.722 to 4.673 g/cm³ with an average of 4.367 g/cm³, a 1.2% difference with respect to the experimental dehydrated paste density, and a standard deviation of 0.209 g/cm³. The average SR was 34.82 μm, approximating the D50 particle size distribution (37 μm) of the SS316L powder, with a standard deviation of 11.765 μm. The measured SR ranged between 18.369 and 72.529 μm.

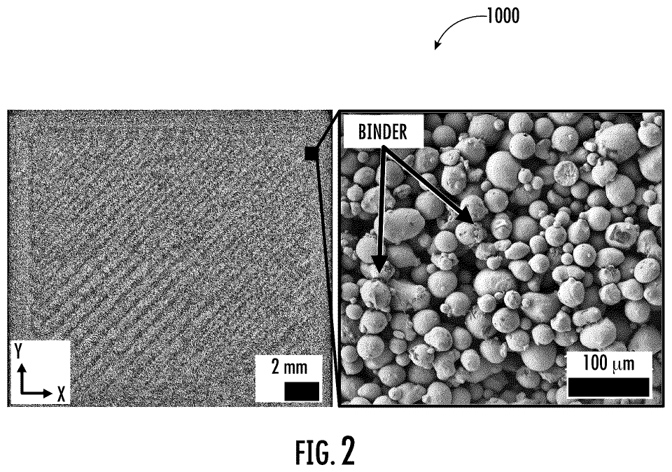

Optical and scanning electron micrographs of run 18, one of the seven parts printed with the four factors set to level zero, are shown in image 1000 of FIG. 2. The layers are discernible in the XZ optical micrograph, with an average thickness of 0.253 mm and a standard deviation of 0.00865 mm based on 20 measurements, which is in excellent agreement with the requested 0.25 mm t_{E}. The XY optical micrograph shows the top layer of the cuboid; the extrudate tracks exhibit homogeneous widths, and there are no visible defects at this scale. The corresponding SEM image captures the composition of the part in the as-printed state; the SS316L powder, clearly visible, is held together by a minuscule quantity of the CMC binder and interparticle forces. The porous network is primarily the result of solvent evaporation during the printing process and will facilitate the subsequent debinding step. In metal FFF, a comparable composition is only feasible after a debinding treatment has been performed.

### 3.1. Factorial Effects on Printed Density

The reduced quadratic model for predicting PD is given by Equation 23 and had an adjusted R² of 0.834. In contrast, the geometric density model (Equation 13) obtained an adjusted R² of 0.219. The supplementary document includes the PD models ANOVA results (tables S2 and S3) and their standardized residuals.

$$PD = + 17.257 {t}_{E} + 28.139 {m}_{E} + 9.171 {w}_{E} - 10.906 {t}_{E} {m}_{E} - 5.406 {t}_{E} {w}_{E} - 6.677 {m}_{E} {w}_{E} - 16.179 - 5.15 {t}_{E}^{2} - 9.5 {m}_{E}^{2} \qquad ( 23 )$$

The subsequent results and discussion on the factorial effects on PD are based on the quadratic model (Equation 23) due to its superior predictive accuracy compared to the geometric model. The main effects for PD, generated with the fitted means using Equation 23.

The extrusion multiplier (m_{E}), with a 37% contribution, was the most dominating factor on PD. The m_{E} 2 term had a 25.4% contribution. The general m_{E} effect on extrudate morphology shows that as m_{E} increased, the voids between adjacent extrudate tracks decreased. As m_{E} increased from 0.9 to 1.2, PD increased by 18.2%; an increase was expected since a higher m_{E} leads to an increase in the deposited mass without significantly changing the cuboids' volume thus yielding higher densities. However, as m_{E} increased from 1.2 to 1.3, PD decreased by 2.8% despite the higher deposited mass due to an accompanying increase in volume. The same pattern was shown by Riaz et al. [65] when 3D printing AISI 8740 steel granules via screw-based MEX; increasing m_{E} from 0.7 to 1.15 led to higher PD, but increasing m_{E} further to 1.30 caused PD to drop.

The extrudate thickness (t_{E}), with a 2.8% contribution, was the second most dominating main effect on PD. The t_{E} 2 term had a 3.7% contribution. The model (Equation 23) suggests that the maximum PD is obtained when t_{E=}0.25 mm (i.e., level 0). A negative relationship between t_{E} and PD may be expected since increasing t_{E} decreases the interlayer contact area and increases voids, thereby reducing PD; however, a negative relationship was only observed as t_{E} increased from 0.25 to 0.45.

The extrusion width (w_{E}), with a 1.4% contribution, was the third most dominating main effect on PD. As w_{E} increased from 0.32 mm to 0.56 mm, PD increased by 2.5%. This w_{E} vs. PD trend is not observed when w_{E}=0.32 mm (level-2), where PD was only 0.1% lower than the density when w_{E}=0.56 mm (level 2). The seemingly high density when w_{E}=0.32 mm is the result of over-extrusion, which led to a cuboid with a 1, 245.8 mm3 volume (3.7% higher than the target 1,200 mm3). In contrast, when w_{E}=0.56 mm, the corresponding volume was 1, 202.6 mm³ (just 0.2% higher than the target volume).

The printing speed (v) had no significant effect on PD, which was expected since the highest v tested was 20 mm/s and the maximum speed the printhead is rated for the selected parameters is 64 mm/s. Assuming adequate printing conditions, equal masses are expected to be extruded regardless of the v level chosen. As v values approach or exceed v_{E,max}, PD is expected to decrease.

Three interaction effects are included in the PD model (Equation 23): m_{E} t_{E}, m_{E}w_{E}, and w_{E}t_{E}. The mate interaction had a 14.1% contribution. The highest predicted PD as a function of m_{E} is obtained when m_{E}=1.2 and as a function of t_{E} when t_{E}=0.25. The m_{E}w_{E} interaction had a 1.9% contribution. When w_{E} is low, increasing mₑ causes a much larger increase in PD than when w_{E} is high. The w_{E}t_{E} interaction had a 1.2% contribution. When t_{E} is low, increasing w_{E} causes a much larger increase in PD than when t_{E} is high.

### 3.2. Factorial Effects on Surface Roughness

The main effects of the parameters on SR is generated. The resulting quadratic model for predicting SR is given by Equation 24 and had an adjusted R² of 0.745. The model's ANOVA results (table S4), predicted accuracy, and standardized residuals are included in the supplementary document.

$$SR = 689.157 - 44.688 {t}_{E} - 13.472 v - 1150.103 {m}_{E} - 2.472 {w}_{E} - 229.031 {t}_{E} {w}_{E} + 10.701 {m}_{E} v + 4.766 {w}_{E} v + 345.082 {t}_{E}^{2} + 508.844 {m}_{E}^{2} \qquad ( 24 )$$

The extrusion multiplier (m_{E}), with a 32.1% contribution, was the most dominating parameter for SR. The m_{E} 2 term had a 27.0% contribution. The effect of m_{E} on SR is now described. When m_{E}=0.9 the part exhibited fairly uniform layers, hence the comparatively small SR value (27.767 μm) obtained. Only the first layer, shown in blue, looks significantly different from the rest as it was printed with the unique parameters mentioned (Sec. 2.3). In contrast, when m_{E}=1.3 the part showed heterogeneous layers which, coupled with protrusions, indicate over-extrusion. The measured SR when m_{E}=1.3 was 72.529 μm, the largest SR obtained for the 31 parts.

The relationship between extrusion speed and the extrusion width and the extrusion multiplier is now discussed. The extrudate thickness (t_{E}), with a 4.3% contribution, was the second most dominating main effect on SR. The t_{E} 2 term had a 6.9% contribution. It was initially expected t_{E} to be positively correlated with SR since lower t_{E} values are known to decrease the stair-stepping effect and thus decrease SR. However, the t_{E} main effect plots resembled a 3rd-degree polynomial function; SR decreased as t_{E} increased from 0.05 to 0.15 mm and from 0.35 to 0.45 mm, only increasing as t_{E} increased from 0.15 to 0.35 mm.

The printing speed (v), with a 1.8% contribution, was the third most dominating main effect on SR, with slower speeds permitting more homogeneous depositions and thus lower SR values. The time to print one layer as a function of v ranged from 8.5 min at the −2 level to 0.9 min at the +2 level. A longer layer time means the layer is closer to its fully dried state and, therefore, less prone to deformations due to the deposition of subsequent layers.

The extrusion width (w_{E}), with a 0.1% contribution, was the least significant main effect on SR. Higher w_{E} resulted in lower SR values.

Three interaction effects are included in the SR model (Equation 24): m_{E}v, t_{E}w_{E}, and w_{E}v. The m_{E}v interaction had an 8.6% contribution. When v is low, increasing m_{E} causes a small increase in SR. In contrast, when v is high, increasing m_{E} leads to a significant increase in SR. The t_{E}w_{E} interaction had a 0.7% contribution. When w_{E} is low, increasing t_{E} causes a larger increase in SR than when w_{E} is high. The w_{E}v interaction had an 0.6% contribution. When w_{E} is high, increasing v causes a larger increase in SR than when w_{E} is low.

3.3. Multi-objective optimization

Table 5 lists the multi-objective optimization (Equation 22) results which suggest that employing the tabulated process parameters enable the fabrication of parts with a printed density of 4.54 g/cm³ and surface roughness of 18.59 μm. Both response values fall within the ranges obtained during the CCD experiments.

Six cuboids were printed with the optimized parameters. The average PD and SR values, 4.67 g/cm³ and 21.54 μm, were within their corresponding model ranges, providing evidence towards the validation of the models.

As will be appreciated, the multi-objective optimization does not necessarily reflect the true optimum PD and SR achievable since the four factors investigated can be further fined-tuned for different extrusion moves and part features. For instance, it's possible to print a part's outer perimeter using a low m_{E} to minimize SR and create its internal structure with a high m_{E} to maximize PD.

Insights from this work have permitted the fabrication of increasingly complex metal partsQualitatively, their quality appears to be on par, if not better, than that achieved via equivalent material extrusion technologies reported in the literature.

TABLE 5
Multi-objective optimization results

| t_{E} | 0.25 | mm |
|---|---|---|
| v | 2.00 | mm/s |
| m_{E} | 1.11 | |
| w_{E} | 0.56 | mm |
| Model PD | 4.54 ± 0.18 | g/cm³ |
| Experimental PD | 4.67 | g/cm³ |
| Model S.R | 18.59 ± 12.56 | μm |
| Experimental SR | 21.54 | μm |

### 3.4. Thermal Treatments

The TGA indicated that the paste's weight rapidly decreased by about 10% as the temperature reached 125° C., corresponding to the solvent removal. The weight slowly fell by 0.1% as the temperature reached 250° C., attributed to moisture release to the CMC structure. The main stage of CMC decomposition, approximately 0.25% weight loss, occurred as the temperature reached around 305° C. The weight decreased a further 0.13% as the temperature increased to 480° C., reaching a final weight of about 89% of the initial weight, corresponding to the feedstock's metal content and suggesting complete binder removal. No further weight changes were recorded until the final temperature of 600° C.

The cuboids printed with the optimal parameters were subjected to the thermal treatments described in section 2.4. The densities derived via Archimedes' method for samples sintered in hydrogen and vacuum were 91.8% and 95.8%, respectively. Densities calculated from image analysis showed the same trend for the two sintering atmospheres; however, densities were approximately 2.1% higher than those calculated using Archimedes' method: 94.0% and 97.9% for parts sintered in hydrogen and vacuum, respectively. In binder jetting studies, a vacuum sintering atmosphere has also yielded denser SS316L parts (95.8-98.3%, [66, 67]) than hydrogen (94.4-97.4%, [68, 62]). The lower densities reported in hydrogen sintering are attributed to hydrogen diffusion and the internal pressure impeding densification and pore shrinkage [69, 70, 71].

Hydrogen-sintered parts had an average surface roughness of 17.2 μm and shrank roughly 15% along the X and Y directions and 18% along the Z direction. Vacuum-sintered parts had an average surface roughness of 14.1 um and shrank about 17% along the X and Y directions and 19% along the Z direction. In sinter-based manufacturing processes, shrinkage in the Z direction is typically higher than that in the XY plane, as observed in metal injection molding [72], metal FFF [20, 73], and binder jetting [67]. The higher shrinkage along the Z direction is attributed to the effect of gravity during sintering [72, 73] and higher interlayer porosity than that within the layers [67].

The advantages of the presented SDFAM approach over metal fused deposition are illustrated through a comparative example. The total fabrication time for the 20 mm XYZ cube using the metal fused deposition approach, estimated using the Markforged Eiger software [74], is at least 103 h, including 3 hours of printing, 68 hours of solvent debinding, 7 hours of drying, and 25 hours of thermal debinding and sintering. Post-processing defects are likely due to the part's high cross-sectional thickness. Karthikesh [75] used an FFF printer (Prusa i3 MK3S) to print a 10 mm thick variant of the XYZ cube using commercially available SS316L filament and attempted to debind and sinter the part in a vacuum atmosphere using an industrial graphite furnace. The post-processed cube exhibited extensive defects, including cracking, distortion, and blisters. In contrast, the SDFAM approach presented in this paper enabled the part to be produced with a density of 95.4% and no visible defects in just 26 hours (4 hours of printing and 22 hours of thermal post-processing).

### 4. Conclusions

A SDFAM framework was developed for manufacturing metallic components, addressing two critical limitations in commercial material extrusion technologies: (1) extremely long post-processing (i.e., debinding and sintering) times, often several days [28, 31], and (2) limited ability to post-process fully dense parts (with no infill) with cross-sectional thicknesses over 4 mm [32]. Both limitations stem from the high binder content, typically around 45 vol % [19], in the filament or pellet feedstocks.

The reported framework included (1) synthesis of a highly-loaded (89.2 wt %) 316L stainless steel paste with just 0.5 wt % binder; (2) design and implementation of a synchronized two-stage extrusion mechanism, including the mathematical background necessary for extrusion control using opensource software; (3) an experimentally-driven approach to evaluate the effects of critical process parameters, including extrudate thickness (t_{E}), extrusion width (w_{E}), extrusion multiplier (m_{E}) and printing speed (v), on printed density (PD) and surface roughness (SR); (4) multi-objective optimization to maximize PD and minimize SR; and (5) evaluation of hydrogen and vacuum sintering strategies.

As concluded from the present disclosure, the optimal multi-objective optimization printing parameters were: t_{E}=0.25 mm, v=2 mm/s, m_{E}=1.11 and w_{E}=0.56 mm. For the range tested, v had no significant effect on PD. Parts fabricated with the optimal printing parameters had an average density of 4.67 g/cm³, 1.5% higher than the powder's tapped density, and an average surface roughness (i.e., Sa) of 21.54 μm. Hydrogen-sintered parts obtained average theoretical densities of 91.8% (Archimedes' method) and 94.0% (image analysis) and SR of 17.2 μm. The parts shrank approximately 15% along the X and Y directions and 18% along the Z direction. Vacuum-sintered parts achieved average densities of 95.8% TD (Archimedes' method) and 97.9% (image analysis) and SR of 14.1 μm. The parts shrank roughly 17% along the X and Y directions and 19% along the Z direction. The 22 hours thermal treatment with vacuum sintering has successfully processed fully dense (i.e., no infill) samples with up to 20 mm cross-sectional thicknesses.

The present disclosure may provide a SDFAM process that is successfully implemented to produce metallic parts with high geometrical fidelity and densities of over 95%, with only 22 hours of thermal post-processing.

TABLE S1
Experimental design and responses

| | t_{E} | v | | w_{E} | PD | SR |
|---|---|---|---|---|---|---|
| Run | (mm) | (mm/s) | m_{E} | (mm) | (g/cm³) | (μm) |
| 1 | 0.35 | 15.5 | 1.2 | 0.50 | 4.413 | 47.876 |
| 2 | 0.25 | 11.0 | 1.1 | 0.44 | 4.508 | 27.674 |
| 3 | 0.35 | 6.5 | 1.0 | 0.50 | 4.226 | 33.841 |
| 4 | 0.25 | 11.0 | 1.1 | 0.32 | 4.456 | 28.361 |
| 5 | 0.35 | 15.5 | 1.0 | 0.50 | 4.423 | 33.125 |
| 6 | 0.35 | 15.5 | 1.0 | 0.38 | 4.371 | 34.252 |
| 7 | 0.25 | 11.0 | 1.1 | 0.44 | 4.513 | 29.713 |
| 8 | 0.15 | 15.5 | 1.2 | 0.50 | 4.542 | 56.625 |
| 9 | 0.35 | 6.5 | 1.2 | 0.38 | 4.349 | 42.034 |
| 10 | 0.25 | 11.0 | 1.1 | 0.44 | 4.481 | 26.233 |
| 11 | 0.15 | 15.5 | 1.0 | 0.38 | 3.956 | 18.369 |
| 12 | 0.45 | 11.0 | 1.1 | 0.44 | 4.392 | 38.603 |
| 13 | 0.15 | 6.5 | 1.0 | 0.38 | 3.895 | 23.449 |
| 14 | 0.25 | 11.0 | 1.1 | 0.44 | 4.318 | 26.204 |
| 15 | 0.25 | 11.0 | 1.1 | 0.56 | 4.461 | 27.867 |
| 16 | 0.35 | 6.5 | 1.0 | 0.38 | 4.254 | 39.555 |
| 17 | 0.15 | 6.5 | 1.2 | 0.50 | 4.643 | 23.718 |
| 18 | 0.25 | 11.0 | 1.1 | 0.44 | 4.518 | 34.075 |
| 19 | 0.25 | 20.0 | 1.1 | 0.44 | 4.527 | 28.268 |
| 20 | 0.15 | 6.5 | 1.2 | 0.38 | 4.549 | 35.639 |
| 21 | 0.05 | 11.0 | 1.1 | 0.44 | 4.091 | 48.592 |
| 22 | 0.35 | 6.5 | 1.2 | 0.50 | 4.414 | 42.350 |
| 23 | 0.15 | 6.5 | 1.0 | 0.50 | 4.277 | 25.706 |
| 24 | 0.25 | 11.0 | 1.1 | 0.44 | 4.498 | 30.124 |
| 25 | 0.35 | 15.5 | 1.2 | 0.38 | 4.425 | 57.113 |
| 26 | 0.25 | 11.0 | 1.3 | 0.44 | 4.413 | 72.529 |
| 27 | 0.25 | 11.0 | 0.9 | 0.44 | 3.722 | 27.767 |
| 28 | 0.25 | 11.0 | 1.1 | 0.44 | 4.379 | 29.849 |
| 29 | 0.25 | 2.0 | 1.1 | 0.44 | 4.497 | 28.282 |
| 30 | 0.15 | 15.5 | 1.0 | 0.50 | 4.207 | 19.653 |
| 31 | 0.15 | 15.5 | 1.2 | 0.38 | 4.673 | 42.020 |

TABLE S2
ANOVA for printed density quadratic model (Eq. 23)

| Source | DOF | Sum Sq | F-vale | p-value |
|---|---|---|---|---|
| Intercept | 1 | 0.266 | 35.524 | <0.001 |
| t_{E} | 1 | 0.252 | 33.592 | <0.001 |
| m_{E} | 1 | 0.389 | 51.829 | <0.001 |
| w_{E} | 1 | 0.038 | 5.050 | 0.035 |
| t_{E}² | 1 | 0.077 | 10.324 | 0.004 |
| m_{E}² | 1 | 0.263 | 35.131 | <0.001 |
| t_{E}m_{E} | 1 | 0.190 | 25.3789 | <0.001 |
| t_{E}w_{E} | 1 | 0.017 | 2.2450 | 0.148 |
| m_{E}w_{E} | 1 | 0.026 | 3.4245 | 0.078 |
| Residuals | 22 | 0.165 | | |
| Adjusted R² | 0.834 | | | |

TABLE S3
ANOVA for geometric density model (Eq. 13)

| Source | DOF | Sum Sq | F-vale | p-value |
|---|---|---|---|---|
| Intercept | 1 | 0.046 | 1.297 | 0.264 |
| ρ_{geometric} | 1 | 0.332 | 9.405 | 0.005 |
| Residuals | 29 | 1.022 | | |
| Adjusted R² | 0.219 | | | |

TABLE S4
ANOVA for SR model (Eq. 24)

| Source | DOF | Sum Sq | F-vale | p-value |
|---|---|---|---|---|
| Intercept | 1 | 799.27 | 21.9127 | <0.001 |
| t_{E} | 1 | 4.69 | 0.1285 | 0.724 |
| v | 1 | 335.18 | 9.1892 | 0.006 |
| m_{E} | 1 | 778.33 | 21.3387 | <0.001 |
| w_{E} | 1 | 0.03 | 0.0007 | 0.978 |
| t_{E}² | 1 | 347.63 | 9.5307 | 0.006 |
| m_{E}² | 1 | 755.87 | 20.7229 | <0.001 |
| t_{E}w_{E} | 1 | 30.21 | 0.8284 | 0.373 |
| vm_{E} | 1 | 371.00 | 10.1712 | 0.004 |
| vw_{E} | 1 | 26.49 | 0.7262 | 0.404 |
| Residuals | 21 | 765.98 | | |
| Adjusted R² | 0.745 | | | |

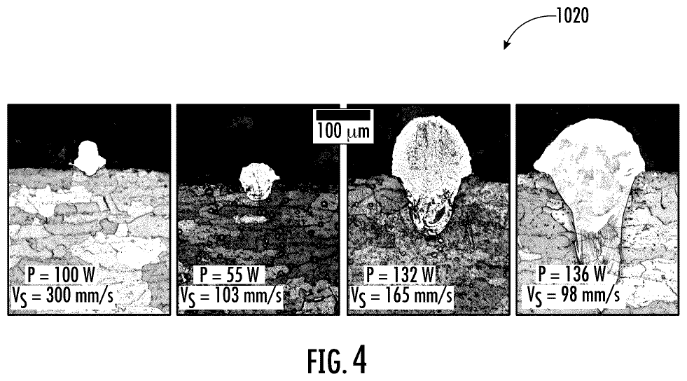

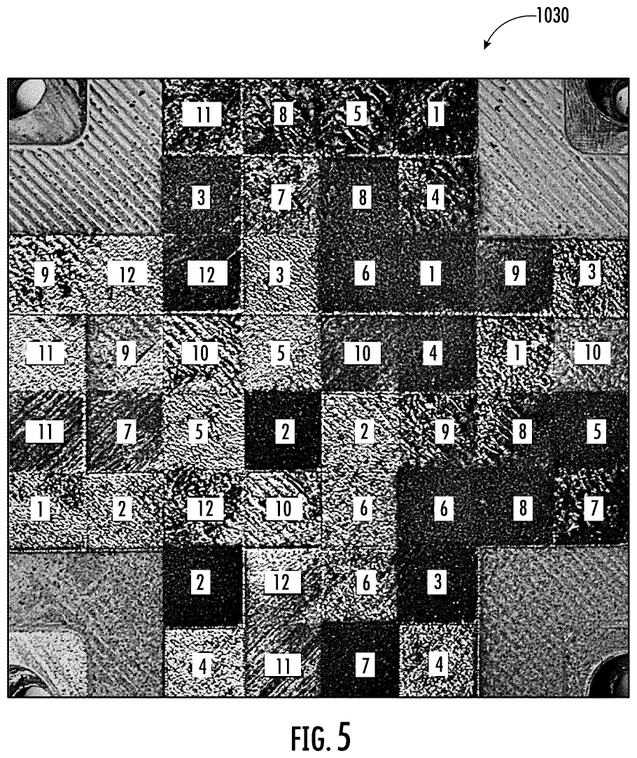

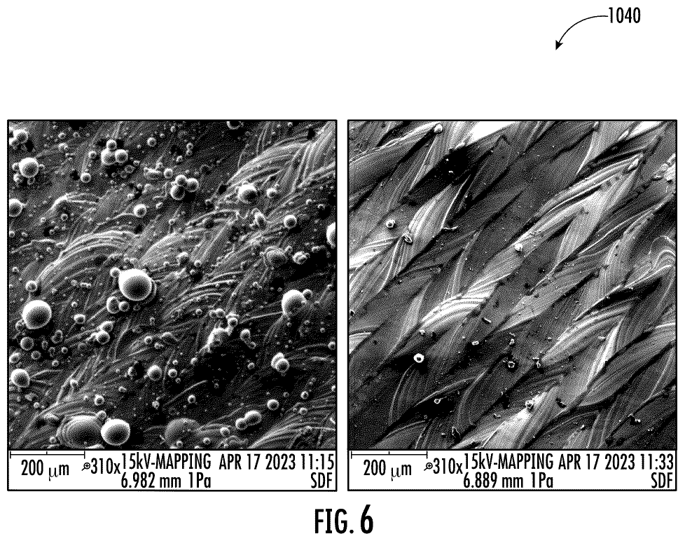

FIGS. 3-6 are diagrams 1010, 1020, 1030, 1040 showing images of a method of additive manufacturing, according to the present disclosure. Diagram 1010 shows single tracks generated by laser scanning a green body produced by material extrusion. Diagram 1020 shows cross-sections of single tracks printed with incorrect (left) and correct (right) laser scanning parameters. Diagram 1030 shows 48 solidified layers generated by selectively laser scanning a green layer printed with material extrusion to test process parameters and impact of a laser debinding protocol. Also, the diagram 1030 shows the single-layer coupons fabricated with example process parameters, still embedded in the green layer. The coupons with dark numbers underwent debinding and melting, while those with lighter numbers were only scanned once with the melting parameters. In Table S5, laser power (P), scan speed (vs), and hatch spacing (h), selected to print multilayer samples. The corresponding volumetric energy density (VED) is included.

TABLE S5

| | Debinding Parameters | | | | Melting Parameters | | | |
|---|---|---|---|---|---|---|---|---|
| | P | vₛ | h | VED | P | vₛ | h | VED |
| ID | (W) | (mm/s) | (μm) | (J/mm³) | (W) | (mm/s) | (μm) | (J/mm³) |
| A | 30.0 | 105 | 98 | 29.2 | 90 | 70 | 98 | 131.2 |
| B | 33.3 | 75 | 129 | 34.5 | 100 | 50 | 129 | 155.0 |
| C | 35.0 | 93 | 109 | 34.5 | 105 | 62 | 109 | 155.4 |
| D | 44.0 | 248 | 69 | 25.8 | 132 | 165 | 69 | 115.9 |

Diagram 1040 shows solidified layers obtained without debinding protocol (left) and with preliminary debinding protocol (right).

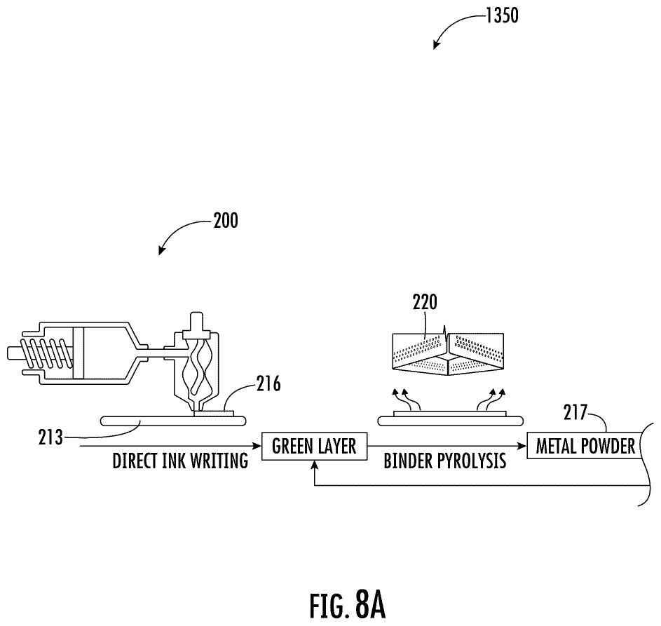

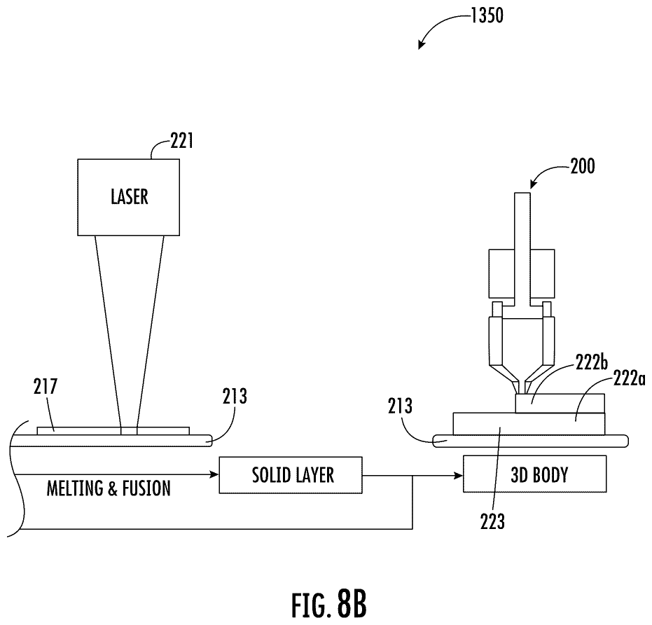

Referring now to FIGS. 1A-1C, and 8A-8B, a SDFAM printer system 200 according to the present disclosure is now described with reference to a diagram 1350. The SDFAM printer system is for performing the below described SDFAM method, for example.

The SDFAM printer system 200 illustratively includes a piston extruder device 201, a printhead device 202 coupled to the piston extruder device via a tube 203, and a controller 204 coupled to the piston extruder device. The piston extruder device 201 illustratively includes a housing 205 defining a feedstock reservoir 206 for the metallic paste, a drive screw 208, and a plunger device 207 carried internally within the housing and coupled to the drive screw. The plunger device 207 is configured to compress the metallic paste and urge it through the tube 203.

The printhead device 202 illustratively includes a printhead body 210 having a first end 211 coupled to the tube 203, and a second nozzle end 212 opposite the first end. The printhead device 202 illustratively includes a positioning system 209 coupled to the printhead body 210 and configured to position extrusion of the metallic paste to form a patterned layer of metallic paste 216 on a build structure 213. In some embodiments, the positioning system 209 may comprise one or more positioning motors, belts, and driven screws. The positioning system 209 is also coupled to the controller 204, which controls the track of the printhead device 202.

As perhaps best seen in FIG. 1C, the second nozzle end 212 has a diameter of ϕ_{flat} and illustratively includes an outlet passageway 214 having a diameter of ϕ_{N}, which is less than ϕ_{flat}. The extruded metallic paste takes the form of a plurality of extrudate tracks 215a-215d, each extrudate track having a height of t_{E} and a width of w_{E}. The space between adjacent extrudate tracks 215a-215d (S_{E}, also known as hatch spacing) is less than w_{E} since an overlap factor reduces the cross-sectional area of voids A_{void}.

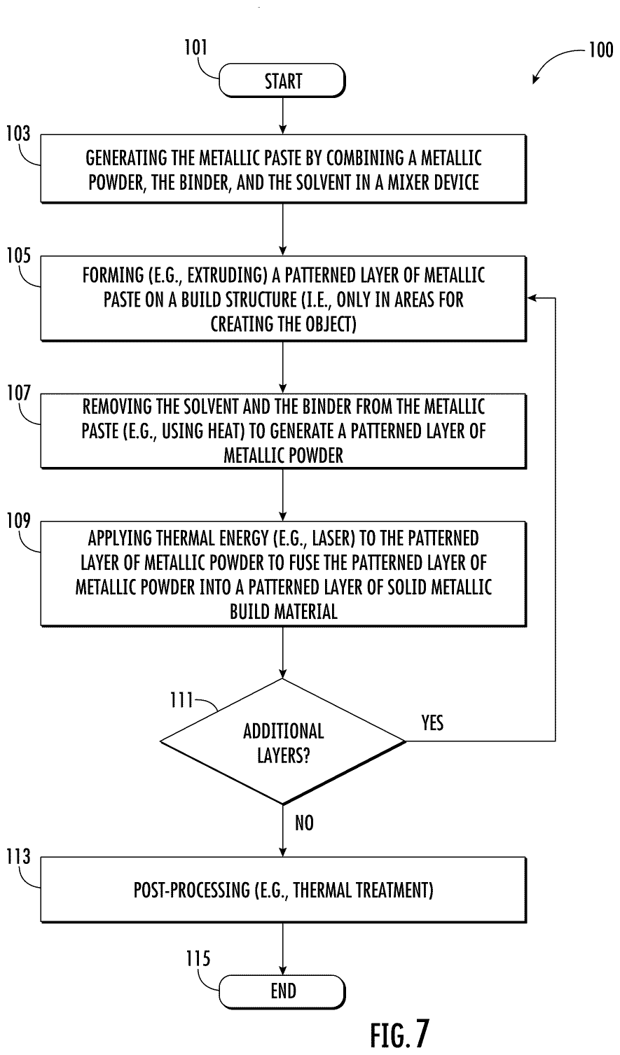

Referring now to FIGS. 7 & 8A-8B, a SDFAM method according to the present disclosure is now described with reference to a flowchart 100 and a diagram 1020, which begins at Block 101. The SDFAM method illustratively includes generating a metallic paste by combining a metallic powder, a binder, and a solvent in a mixer device. (Block 103). For example, the metallic powder may comprise a stainless steel powder. Nonetheless, it should be appreciated that other metal powders/pastes/compounds can be used with the herein disclosed SDFAM method.

The SDFAM method comprises forming a patterned layer of metallic paste 216 on a build structure 213. (Block 105). For example, the build structure 213 may comprise a build plate (substrate) or a build chamber.

For example, the metallic paste may comprise at least 90 wt % metal powder. The metallic paste may comprise less than 1 wt % binder. The binder may comprise carboxymethyl cellulose, and the solvent may comprise deionized water, for example.

The forming of the patterned layer of metallic paste 216 comprises forming the metallic paste only in areas for creating the object. In some embodiments, the forming of the patterned layer of metallic paste 216 may comprise extruding the patterned layer of metallic paste. In other words, this helpfully reduces consumption of feedstock as compared to typical approaches.

The method illustratively comprises removing the solvent and the binder from the metallic paste to generate a patterned layer of metallic powder 217. (Block 107). The removing of the solvent and the binder may comprise heating the metallic paste to a first temperature in an oven 220. The removing of the solvent and the binder may comprise a single stage process in some embodiments.

The SDFAM method also includes applying thermal energy to the patterned layer of metallic powder 217 to fuse the patterned layer of metallic powder into a patterned layer of solid metallic build material 220. (Block 109). In some embodiments (FIGS. 8A-8B), the applying of the thermal energy may comprise using a scanning laser 221 to generate the thermal energy.

The SDFAM method also includes repeating the forming, the removing, and the applying to form a plurality of patterned layers 222a-222b of solid metallic build material to create an object 223 (i.e., with no infill). (Block 111). Also, the SDFAM method may include a post-processing for the object 223. (Block 113). The post-processing may comprise applying thermal energy to the object 223, and the post-processing may be less than 24 hours. The method ends at Block 115.

Helpfully, the integration of paste deposition system and heat source(s) in a single machine to process a metal paste feedstock (e.g., ˜90 wt % metal powder, under 1 wt % binder, and a volatile solvent) enable the solution to the problems noted in the prior art approaches. In particular, encapsulating the metal powder into an extrudable paste addresses the difficulties in dealing with loose powders. The selective deposition step means that powder is being deposited only in regions that will make up the built part, as opposed to powders being deposited or spread across the entire build area, thus improving feedstock efficiency and permitting the fabrication of fully enclosed partial infills or lattice structures. Lastly, since no powder surrounds the part's perimeter, surface roughness would improve.

Advantageously, in the SDFAM method, the printing of the metallic paste, the subsequent debinding and fusion using thermal energy, and repeating the process in a layerwise fashion is all done in one process step. This contrasts with needing two separate processes in prior art DIW approaches, in particular, a printer and a subsequent furnace. Further, SDF provides a new AM process for in-space manufacturing that integrates the benefits of DIW of 316L pastes with laser-based processing to locally debind and subsequently melt and fuse 316L powder, layer by layer. This is in contrast to PBF processes that spread powder across the entire build surface, and filament-based MEX processes that rely on multiple machines (e.g., 3D printer, debinding unit, sintering furnace); thus, necessitating additional footprint and power requirements.

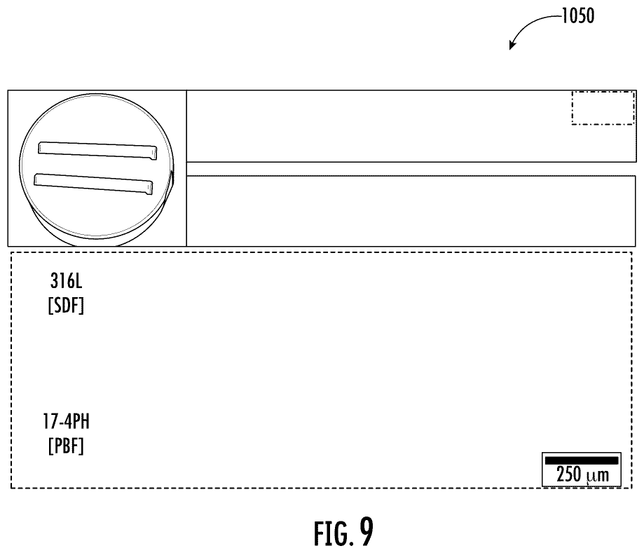

Referring now to FIGS. 9-13, diagram 1050 shows two polished cross-sections obtained for a multilayer sample. In the magnified micrograph, two regions corresponding to the 17-4PH fabricated via PBF and SS316L fabricated via SDF are visible. The porosity seen in the 17-4PH regions is attributed to using a recycled powder. Overall, the SS316L region showed good metallurgical bonding at the interface with the 17-4PH.

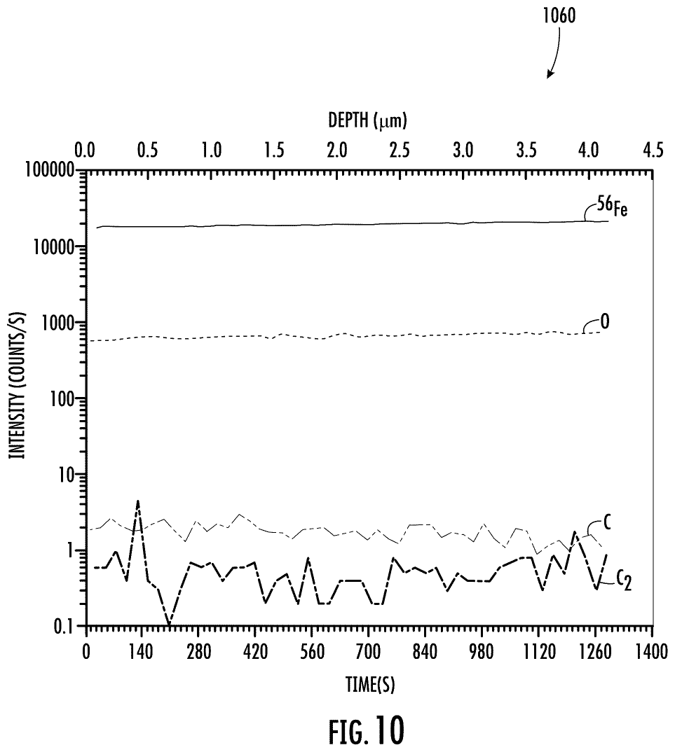

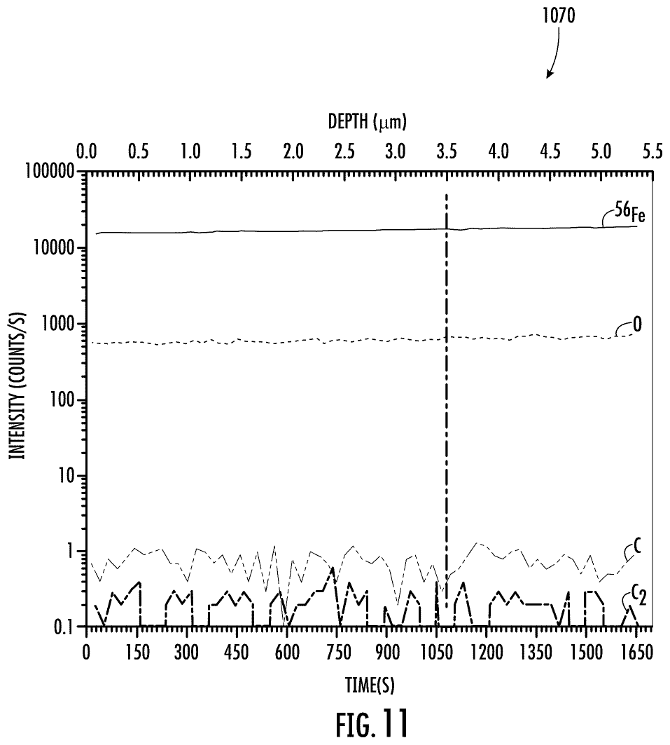

The secondary-ion mass spectrometry (SIMS) depth profiles measuring the carbon (C) and iron (Fe) elemental compositions in the virgin SS316L powder are shown in FIGS. 10-11 (diagrams 1060, 1070). The average C/Fₑ signal ratio was 7.251×10⁻⁵. Attempts were made to obtain SIMS depth profiles of a green layer, but the ion options could not be focused on SS316L particles without excessive blurring, likely due to a charging effect.

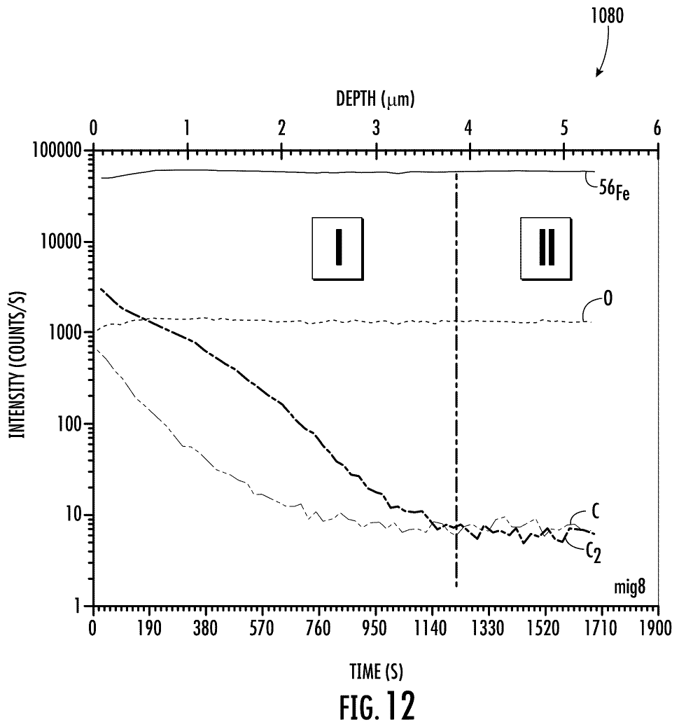

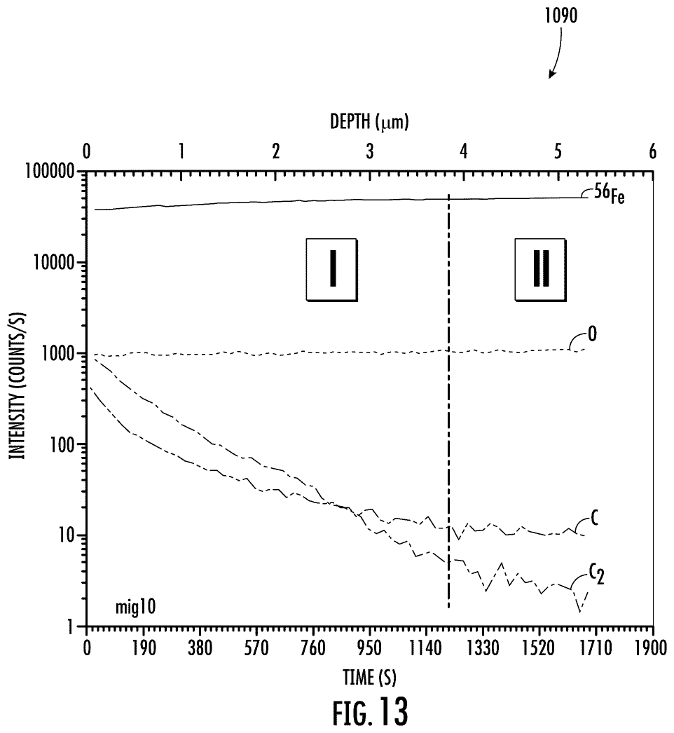

The SIMS depth profiles measuring the C and Fe elemental compositions in multilayer sample B are shown in FIGS. 12-13 (diagrams 1080, 1090). The unstable C signal in region I (from top to depth of approximately 3.5 μm) corresponds to contaminants inserted during the polishing and handling, while region II, used to compute the C/Fe signal ratios, belongs to the SS316L bulk volume. The average C/Fₑ signal ratio for SDF sample B was 1.571×10−4.

Finally, the C wt % in sample B can be estimated using Equation 25 and the known C content in the virgin SS316L powder (0.007 wt %). The estimated C wt % in sample B was 0.0152%, which is safely below the acceptable limit (0.03 wt %) for SS316L.)

$${C}_{wt \% sample} = \frac{1.571 \times {10}^{- 4}}{7.251 \times {10}^{- 5}} \cdot {C}_{wt \% powder} \qquad ( 25 )$$

Listing of References cited herein may be found in copending Application No. 63/502,749 filed May 17, 2023, the entire subject matter of which is incorporated herein by reference in its entirety.

The contents of the paper by the inventors (“Selective Deposition and Fusion of AISI 316L: An Additive Manufacturing Process for Space Environments via Direct Ink Writing and Laser Processing”, Miguel Hoffmann, Jiahui Yea, Alaa Elwanya, Journal of Manufacturing Science and Engineering) are incorporated by reference in their entirety.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A selective deposition and fusion (SDF) additive manufacturing (AM) method, the SDFAM method comprising:
forming a patterned layer of metallic paste on a build structure, the metallic paste comprising a solvent and a binder;
removing the solvent and the binder from the metallic paste to generate a patterned layer of metallic powder;
applying thermal energy to the patterned layer of metallic powder to fuse the patterned layer of metallic powder into a patterned layer of solid metallic build material; and
repeating the forming, the removing, and the applying to form a plurality of patterned layers of solid metallic build material to create an object.

2. The SDFAM method of claim 1 further comprising generating the metallic paste by combining a metallic powder, the binder, and the solvent in a mixer device.

3. The SDFAM method of claim 1 wherein the forming of the patterned layer of metallic paste comprises forming the metallic paste only in areas for creating the object.

4. The SDFAM method of claim 1 wherein the applying of the thermal energy comprises using a scanning laser to generate the thermal energy.

5. The SDFAM method of claim 1 further comprising a post-processing for the object.

6. The SDFAM method of claim 5 wherein post-processing comprises applying thermal energy to the object; and wherein the post-processing is less than 24 hours.

7. The SDFAM method of claim 1 wherein the forming of the patterned layer of metallic paste comprises extruding the patterned layer of metallic paste.

8. The SDFAM method of claim 1 wherein the metallic paste comprises at least 90 wt % metal powder.

9. The SDFAM method of claim 1 wherein the metallic paste comprises less than 1 wt % binder.

10. The SDFAM method of claim 1 wherein the binder comprises carboxymethyl cellulose; and wherein the solvent comprises deionized water.

11. The SDFAM method of claim 1 wherein the removing of the solvent and the binder comprises heating the metallic paste to a first temperature.

12. The SDFAM method of claim 1 wherein the removing of the solvent and the binder comprises a single stage process.

13. The SDFAM method of claim 1 wherein the object has no infill.

14. A selective deposition and fusion (SDF) additive manufacturing (AM) method, the SDFAM method comprising:
generating a metallic paste by combining a metallic powder, a binder, and a solvent in a mixer device;
extruding a patterned layer of metallic paste on a build structure, the metallic paste comprising at least 90 wt % metal powder and less than 1 wt % binder;
removing the solvent and the binder from the metallic paste in a single stage process to generate a patterned layer of metallic powder;
applying thermal energy to the patterned layer of metallic powder to fuse the patterned layer of metallic powder into a patterned layer of solid metallic build material; and
repeating the extruding, the removing, and the applying to form a plurality of patterned layers of solid metallic build material to create an object with no infill.

15. The SDFAM method of claim 14 wherein the extruding of the patterned layer of metallic paste comprises extruding the metallic paste only in areas for creating the object.

16. The SDFAM method of claim 14 wherein the applying of the thermal energy comprises using a scanning laser to generate the thermal energy.

17. The SDFAM method of claim 14 further comprising a post-processing for the object.

18. The SDFAM method of claim 17 wherein post-processing comprises applying thermal energy to the object; and
wherein the post-processing is less than 24 hours.

19. The SDFAM method of claim 14 wherein the binder comprises carboxymethyl cellulose; and wherein the solvent comprises deionized water.

20. The SDFAM method of claim 14 wherein the removing of the solvent and the binder comprises heating the metallic paste to a first temperature.
